(19) United States
(12) Patent Application Publication
(10) Pub. No.: US 2016/0046001 A1
(43) Pub. Date: Feb. 18, 2016

(54) EXPANDABLE LOCKING MECHANISM AND METHOD OF USE

(71) Applicant: Kreg Enterprises, Inc., Huxley, IA (US)

(72) Inventors: Scott L. Clark, Boone, IA (US); Joe Gibson, Polk City, IA (US); Jan Svec, Des Moines, IA (US)

(21) Appl. No.: 14/825,733

(22) Filed: Aug. 13, 2015

Related U.S. Application Data
(60) Provisional application No. 62/037,472, filed on Aug. 14, 2014.

(51) Int. Cl. B25B 5/00

(52) U.S. Cl. CPC B25B 5/006

(57) ABSTRACT

An expandable locking mechanism having a mounting plate and an anchor mechanism. A clamp is attached to the mounting plate and the anchor mechanism, which extends through the mounting plate, is connected to a work bench

### CROSS REFERENCE TO RELATED APPLICATION

This application claims the benefit of U.S. Provisional Application No. 62/037,472 filed August 14, 2014.

### FIELD OF THE INVENTION

This invention relates generally to hand tools. More specifically, and without limitation, this invention relates to a locking mechanism for use with hand tools.

### BACKGROUND OF INVENTION

An endless array of hand tools exist. Each tool is specifically designed for a particular use or an array of particular uses. On category of hand tools are known as clamping mechanisms or simply clamps. Traditionally, clamps are used to hold two workpieces together, or to hold one or more workpieces stationary so as to make it easier to perform additional processes on the workpiece without fear of the workpiece moving.

One common type of clamp is simply know as a C-clamp. Conventionally, C-clamps have an upper arm and a lower arm that reach around the edge of a work bench (hereinafter work bench) and workpiece. C-clamps have an operating mechanism, such as a screw-type mechanism, ratchet mechanism, slide mechanism or the like that serve to move the upper arm toward the lower arm thereby tightening the workpiece against the work table.

While conventional C-clamps are useful in some applications, they do have their limitations and deficiencies. Namely, because C-clamps must reach around the edge of the work bench as well as the workpiece, C-clamps are limited to the ways in which they can be used. That is, they can only be used at or near the edge of a work bench. In addition, conventional C-clamps are time consuming and inconvenient to operate.

Another common type of clamp is known as a “bench clamp.” Applicant, Kreg Tool Company, 201 Campus Drive, Huxley, Iowa 50124, commercially sells a variety of bench clamps. Common components of a bench clamp include a clamping arm that is movable between an open position and a clamping position by operation of a first handle and a second handle. These bench clamps often include a base that is slidably connected to a track that is bolted to the work bench, or is formed as part of the work bench.

While conventional bench clamps are useful in some applications, they do have their limitations and deficiencies. Namely, requiring an additional track system to attach a bench clamp is not only expensive, but track systems require additional installation steps, are expensive and may not be compatible with every work bench. In addition, the use of a track system may be altogether incompatible with some applications.

Therefore, for the reasons stated above, and for other reasons stated below which will become apparent to those skilled in the art upon reading and understanding the specification, claims and drawings, there is a need in the art for an improved locking mechanism and method of use.

Thus, an object of the invention is to provide a locking mechanism and method of use that improves upon the present state of the art.

Another object of the invention is to provide an improved locking mechanism and method of use that can be installed on practically any work bench.

Yet another object of the invention is to provide an improved locking mechanism and method of use that can be installed at practically any place on a work bench.

Another object of the invention is to provide an improved locking mechanism and method of use that does not require a track system to install the locking mechanism.

Yet another object of the invention is to provide an improved locking mechanism and method of use that can be quickly installed.

Another object of the invention is to provide an improved locking mechanism and method of use that can be quickly removed.

Yet another object of the invention is to provide an improved locking mechanism and method of use that is simple to use.

Another object of the invention is to provide an improved locking mechanism and method of use that is easy to use.

Yet another object of the invention is to provide an improved locking mechanism and method of use that is does not require connecting any additional parts or components to a work bench to install the system.

Another object of the invention is to provide an improved locking mechanism and method of use that is safe to use.

Yet another object of the invention is to provide an improved locking mechanism and method of use that is relatively inexpensive to manufacture.

Another object of the invention is to provide an improved locking mechanism and method of use that provides new and additional ways of attaching tools and other objects to a work bench.

Yet another object of the invention is to provide an improved locking mechanism and method of use that allows for added flexibility of use.

Another object of the invention is to provide an improved locking mechanism and method of use that can be used with a wide array of work processes.

Yet another object of the invention is to provide an improved locking mechanism and method of use that can be used in a wide array of industries.

Another object of the invention is to provide an improved locking mechanism and method of use that can be used with a wide array of workpiece thicknesses in a quick and easy manner.

Yet another object of the invention is to provide an improved locking mechanism and method of use that is robust.

Another object of the invention is to provide an improved locking mechanism and method of use that is forgiving.

Yet another object of the invention is to provide an improved locking mechanism and method of use that has a long useful life.

Another object of the invention is to provide an improved locking mechanism and method of use that is durable.

Yet another object of the invention is to provide an improved locking mechanism and method of use that has an intuitive design.

Another object of the invention is to provide an improved locking mechanism and method of use that improves the speed and ease of performing work processes.

These and other objects, features, or advantages of the invention will become apparent from the specification and claims.

### SUMMARY OF THE INVENTION

An expandable locking mechanism is presented that includes a mounting plate with an anchor mechanism connected thereto. The anchor mechanism includes a handle mechanism, a bushing, an upper plug, an expansion mechanism formed of a plurality of wedges, a lower plug and a fastener that extend through these components. The bushing is inserted into an opening in the mounting plate or other tool or object and the expansion mechanism is inserted into a mounting hole in a work bench. The fastener is operated by the handle mechanism thereby causing the lower plug to engage the expansion mechanism causing it to expand within the mounting hole locking the mounting plate to the work bench. Once mounted a bench clamp or other tool or device is attached to the mounting plate and is used to clamp workpieces against the work bench. The locking mechanism is removed by the opposite process. As such, an improved locking mechanism is presented that can be quickly and easily installed and removed from any mounting hole in a work bench.

### BRIEF DESCRIPTION OF THE DRAWINGS

FIG. 1 is a perspective view of a clamp and a locking mechanism;

FIG. 2 is a bottom perspective view of a clamp and a locking mechanism;

FIG. 3 is a side sectional view of a locking mechanism;

FIG. 4 is an exploded perspective view of a locking mechanism;

FIG. 5 is an exploded perspective view of a locking mechanism;

FIG. 6 is a side sectional view of an anchor mechanism;

FIG. 7 is a side sectional view of an anchor mechanism;

FIG. 8 is a perspective view of an anchor mechanism;

FIG. 9 is a side view of a clamp and a locking mechanism;

FIG. 10 is an exploded perspective view of a clamp and locking mechanism;

FIG. 11 is a side view of a clamp and a locking mechanism;

FIG. 12 is a perspective view of a clamp and an anchor mechanism;

FIG. 13 is a perspective view of a clamp and an anchor mechanism;

FIG. 14 is a perspective view of a work bench;

FIG. 15 is a perspective view of a work bench;

FIG. 16 is a perspective view of clamps and anchor mechanisms on a work bench; and

FIG. 17 is a perspective view of a work bench.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

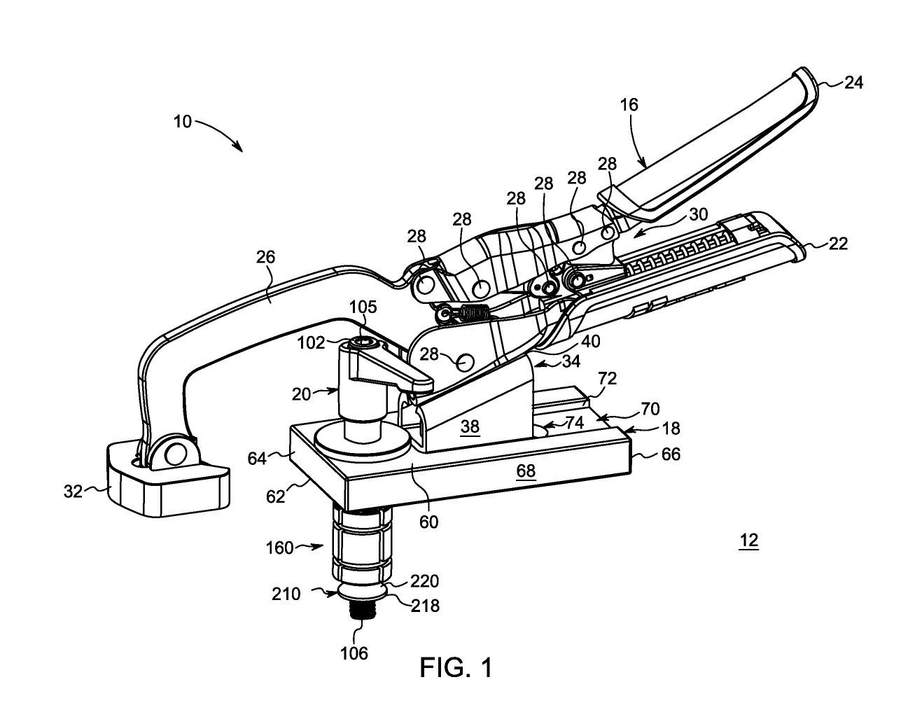

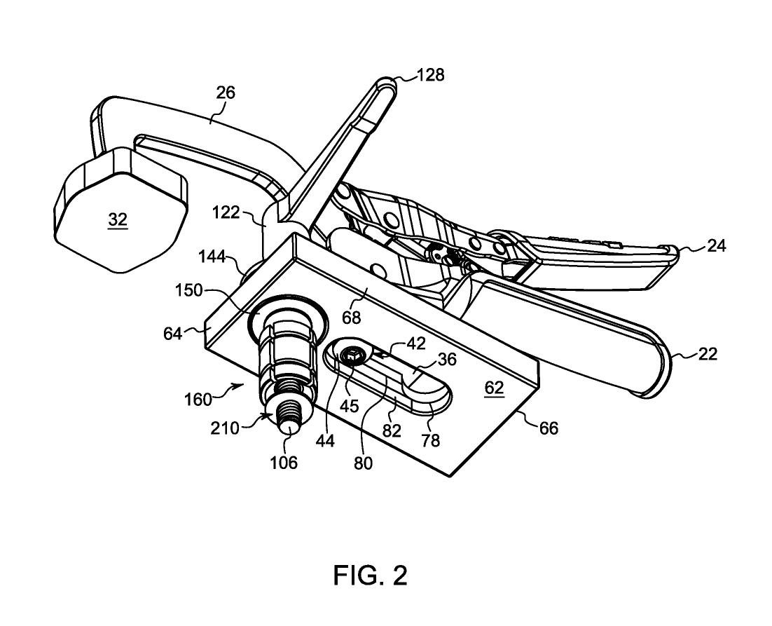

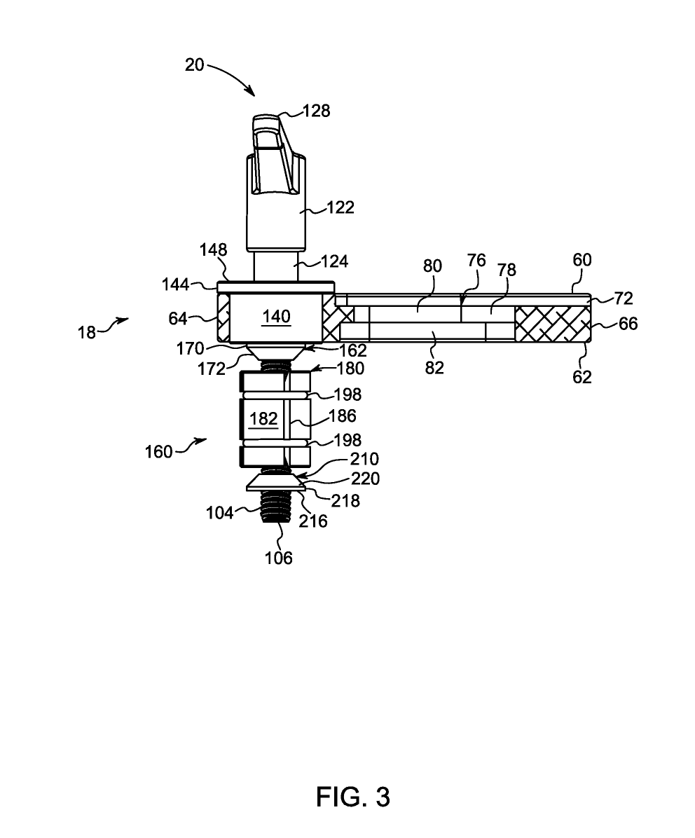

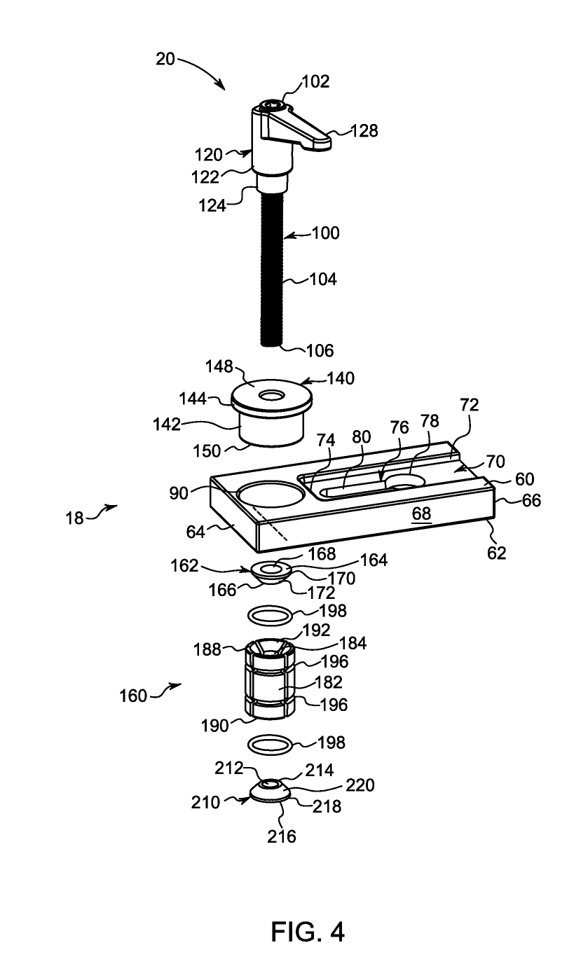

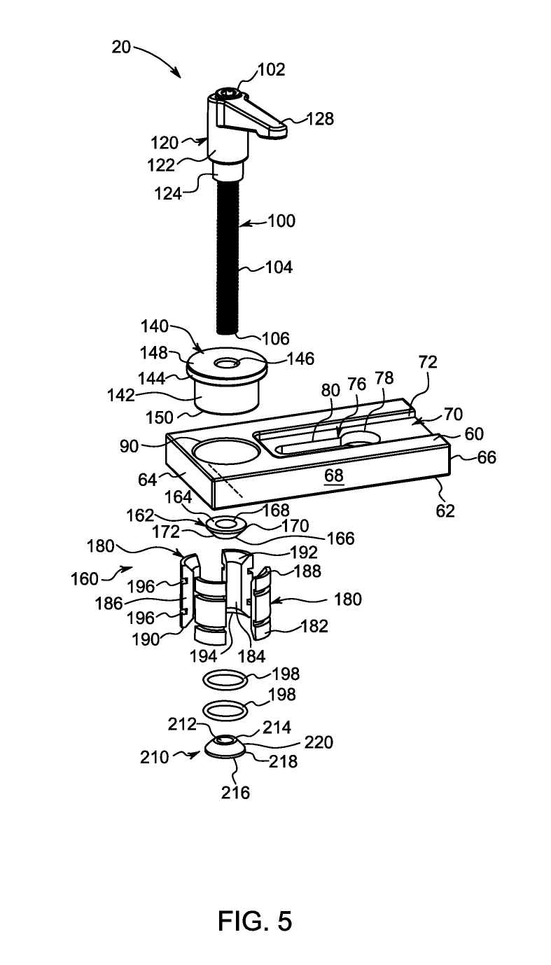

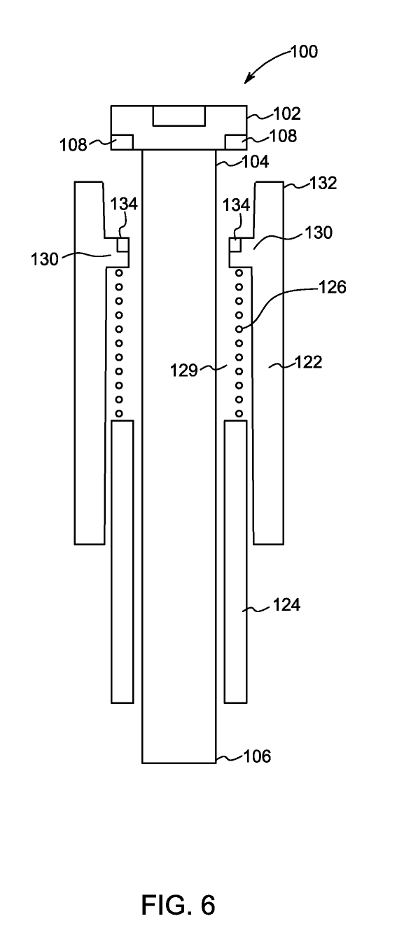

With reference to FIGS. 1-6, a first embodiment of an expandable locking mechanism, or system 10, is presented. The system 10 is used in association with a work bench 12 into which a mounting hole 14 is located. The system 10 includes a bench clamp 16, a mounting plate 18 and an anchor mechanism 20.

Work Bench: The term work bench 12 as used herein means not only any form of a work bench or work surface onto which workpieces are placed to perform operations, but the term is to be more-broadly construed. That is, the term work bench as used herein is means any form of a structure or object into which a mounting hole (or mounting slot) can be formed thereby allowing the expandable mechanism to be inserted and the system 10 attached thereto. While most conventional work benches are flat horizontal surfaces, the term as used herein is not so limited. The system 10 holds itself in place and therefore the work bench 12 can be oriented in any position or angle, including vertical or upside down.

Bench Clamp: Any form of a bench clamp 16 is contemplated for use in association with the system 10 described herein. In one arrangement, as is shown in the Figures, a bench clamp 16 sold by Applicant, Kreg Tool Company, 201 Campus Drive, Huxley, Iowa 50124 under the name “Automaxx™ Bench Klamp” is shown. These Kreg Tool Automaxx™ Bench Klamps include a lower handle 22, an upper handle 24 and a clamping arm 26 connected to one another at a plurality of pivot points 28 with an adjustment mechanism 30 connected thereto and positioned there between. In one arrangement, adjustment mechanism 30 is formed of a plurality of components that automatically adjust for variations in workpiece thickness. Additional information about possible arrangements for the adjustment mechanism 30 may be found in the following U.S. Patents: U.S. Pat. No. 8,613,433 issued to Robert N. Poole and Daniel Poole on Dec. 24, 2013 entitled SELF ADJUSTING TOGGLE CLAMP; U.S. Pat. No. 6,776,072 issued to Robert N. Poole and Daniel Poole on Aug. 17, 2004 entitled ADJUSTABLE PLIERS WRENCH; and U.S. Pat. No. 6,591,719 072 issued to Robert N. Poole and Daniel Poole on Jul. 15, 203 entitled ADJUSTABLE PLIERS WRENCH, all of which are fully incorporated by reference herein including any related patent applications or applications or patents cited therein.

A clamping pad 32 is pivotally connected to the outward end of clamping arm 26. Clamping pad 32 provides a greater amount of surface area to the end of clamping arm 26 and thereby prevents marking a workpiece when clamped. By pivoting on the end of clamping arm 26 the clamping pad 32 adjusts for various clamping angles due to varying thicknesses of workpieces.

A base 34 is connected to bench clamp 16. Base 34 is made of any suitable size, shape and design. In the arrangement shown, base 34 is connected to the lower edge of lower handle 22 and extends downward therefrom a distance. The bottom surface 36 of base 34 is generally flat and square or rectangular that connects at its outward sides to upward extending sidewalls 38 that are generally flat as well and extend in generally parallel spaced relation to one another and extend in a generally perpendicular plane to the plane formed by the bottom surface 36. The upper edge of sidewalls 38 terminates in an upper surface 40 that defines a plane that is positioned at an angle with respect to the plane defined by the bottom surface 36. The plane formed by the upper surface 40 angles downward as it extends forward, from the lower handle 22 towards the clamping pad 32 connected to the end of the clamping arm 26. This angle helps to position the lower handle 22 a comfortable distance above upper surface of work bench 12. Lower handle 22 is connected to base 34 by any means known in the art, either permanently or removably, such as forming the two components out of a single piece of material by stamping, casting or machining, or welding the two components together, or by screwing or bolting the two components together, or by connecting the two components by any other manner, method or means.

A mounting member 42 is connected to base 34. In the arrangement shown, mounting member 42 extends out of the bottom surface 36 of base 34 a distance. As an example, mounting member 42 is a screw or bolt having a head 44 with a screw-drive mechanism 45 used to rotate the device such as flat head, Philips head, square head, hex head, six sided, or the like device that is used to rotate the device, connected to the end of a threaded shaft 46 that is threadably received within the base 34. Base 34 and mounting member 42 are used in combination to connect to mounting plate 18 as is further described herein.

Mounting Plate: Mounting plate 18 is formed of any suitable size, shape and design. In one arrangement, as is shown, mounting plate 18 is a generally rectangular member having generally flat upper surface 60 and a generally flat lower surface 62 that are positioned in approximate parallel spaced alignment to one another. Mounting plate 18 extends between a forward wall 64 and a rearward wall 66 that extend in approximate parallel spaced alignment to one another. Opposing sidewalls 68 extend in approximate parallel spaced alignment to one another between forward wall 64 and a rearward wall 66, forward wall 64 and a rearward wall 66 extend in approximate perpendicular alignment to sidewalls 68.

A mounting groove 70 is positioned in mounting plate 18. Mounting groove 70 is formed of any suitable size, shape and design, and is generally sized and shaped to removably and replaceably receive base 34 of bench clamp 16. More specifically, mounting groove 70 is generally rectangular in shape, when viewed from above, and is sized just larger than bottom surface 36 of base 34. Mounting groove 70 is recessed a distance below the upper surface 60 of mounting plate 18 and intersects with rearward wall 66. Mounting groove 70 is defined by opposing sidewalls 72 that are positioned in generally parallel spaced relation and an end wall 74 that intersects with sidewalls 72 in generally perpendicular alignment. End wall 74 serves as a forward-most stop for base 34 when mounting member 42 is in place within keyhole 76.

A keyhole 76 is positioned in mounting groove 70. Keyhole 76 is formed of any suitable size, shape and design and serves a connecting feature for other components described herein. In the arrangement shown, keyhole 76 includes a first section 78 positioned rearward of and connected to a second section 80. First section 78 is a generally cylindrical opening, when viewed from above or below that extends vertically though the thickness of mounting plate 18 and is sized and shaped to allow the head 44 of mounting member 42 to pass there through with close or tight tolerances. Second section 80 connects to the forward side of first section 78 and is narrower than the first section 78. Second section 80 is sized and shaped to allow the shaft 46 to pass there through, while preventing head 44 to pass there through. Second section 80 is elongated and allows shaft 46 to slide a distance therein once head 44 is inserted through first section 78 thereby ensuring that the mounting member 42 is retained within the second section 80 of keyhole 76 and is prevented from vertically escaping the keyhole 76. Thus, the key hole 76 allows the head 44 of mounting member 42 to be inserted within the first section 78; and once head 44 is inserted within first section 78 the mounting member 42 is moved forward within the slot of second section 80 which prevents head 44 from being vertically pulled through keyhole 76.

A cutout section 82 is positioned in the lower surface 62 of mounting plate 18 that corresponds with the keyhole 76. Cutout section 82 is deeper than the height of head 44 such that head 44 does not protrude past the lower surface 62 of mounting plate 18 when mounting member 42 is retained within keyhole 76. That is, cutout section 82 is deeper than the height of head 44. This arrangement prevents head 44 from protruding from the lower surface 62 of mounting plate 18 and engaging or interfering with the work bench 12. This arrangement allows a bench clamp 16 to be installed onto or removed from mounting plate 18 when mounting plate 18 is attached to work bench 12. In the arrangement shown, cutout section 82 has a flat upper surface with flat and straight sidewalls that extend downward therefrom and terminate in rounded ends.

A through hole 90 is positioned just forward of mounting groove 70 and just rearward of the forward wall 64. Through hole 90 is generally cylindrical in shape when viewed from above or below and extends from the upper surface 60 to the lower surface 62 of mounting plate 18.

Through hole 90 is used to removably and replaceably mount mounting plate 18 to a work bench 12 using locking mechanism 10.

Mounting plate 18 is useful in some arrangements, however in other arrangements no such mounting plate 18 is used or necessary. In these arrangements, locking mechanism 10 is attached directly to the object or tool itself, as is further described herein, or alternatively locking mechanism 10 is formed in or a part of the object or tool itself.

Anchor Mechanism: Anchor mechanism 20 is formed of any suitable size, shape and design. In one arrangement, as is shown, anchor mechanism 20 is generally elongated in shape.

Anchor mechanism 20 includes a fastener 100 that extends through approximately the center of anchor mechanism 20. Fastener 100 includes a head 102 positioned at its upper end and a wholly or partially threaded shaft 104 extending downward therefrom before terminating in end 106. The upper surface of head 102 includes a screw-drive mechanism 105 which may be used to rotate the device such as flat head, Philips head, square head, hex head, six sided, or the like device or arrangement. In the arrangement shown, head 102 is generally circular in shape when viewed from above or below and has a larger diameter than the shaft portion that extends downward from head 102.

In one arrangement, head 102 includes grip features 108 therein that help to facilitate rotation of the shaft 104 as is further described herein. These grip features 108 are formed of any size, shape and design and in one arrangement are teeth, grooves or protrusions positioned in the bottom of head 102 in the portion that overhangs shaft 104. In another arrangement, grip features 108 are formed of out-of-round protrusions that extend outward the exterior edge of head 102, such as one or more fingers, bumps or protrusions, or inward into the exterior edge of head 102 such as cuts or grooves. In yet another arrangement, grip features 108 are formed by a non-round head 102 such as square, rectangular, diamond, triangular, hexagonal, heptagonal, cross-shaped, pentagonal, or by forming head 102 out of any other non-round shape. In one arrangement, a handle mechanism 120 is connected to and positioned around fastener 100, just below head 102. Handle mechanism 120 is any form of a device that is used to rotate fastener 100 by hand. The use of a handle mechanism 120 eliminates the need to use a separate tool, such as a screwdriver, to rotate fastener 100. In one arrangement, it is desirable to not have handle mechanism 120 and to rely upon a separate tool, such as a screwdriver, to operate fastener 100. In another arrangement, it is desirable to have a handle mechanism 120 to improve convenience and to obviate the need to use a separate tool to rotate fastener 100.

In the arrangement shown, handle mechanism 120 includes an upper portion 122 that slidably fits over a lower portion 124. A bias member 126, such as a spring or compressible member, is positioned between the upper portion 122 and lower portion 124 and provides a force causing upper portion 122 to engage head 102 of fastener 100.

In the arrangement shown, upper portion 122 has a generally cylindrical exterior surface with at least one handle portion 128 extending outwardly therefrom so as to provide rotational leverage to rotate fastener 100. While in the arrangement shown, a single handle portion 128 extends outward from the upper portion 122 in an L-shaped fashion, a pair of handle portions 128 are hereby contemplated for use such as in a T-shaped fashion, as are three handle portions 128, four handle portions 128, five handle portions 128 or more handle portions 128 that extend outward from the center in a star fashion, or alternatively a knob can be used as handle portion 128, or any other suitable size, shape or design can be used for handle portion 128 that provides the user with enough leverage to rotate fastener 100.

Upper portion 122 has a generally cylindrical hollow interior 129 that receives fastener 100 therein. A collar 130 is positioned a distance below the upper end 132 of upper portion 122 and extends into the hollow interior 129 a distance. Collar 130 is sized and shaped to allow the shaft 104 of fastener to extend there through but it is too narrow to allow head 102 to pass there through. As such, collar 130 provides a stop for head 102. Collar 130 is positioned such that when fastener 100 is positioned in handle mechanism 120 the head 102 is generally flush or does not protrude above the upper end 132 of upper portion 122.

The upper surface and/or inner surface of collar 130 includes grip features 134 that correspond to or mate with the grip features 108 in the bottom surface and/or outward surface of head 102 of fastener 100. In this way, when the bias member 126 forces upper portion 122 upward, the grip features 134 in the upper surface and/or inward surface of collar 130 engage and mate with the corresponding grip features 134 in the lower surface or outward surface of head 102 of fastening member 100.

To rotate the fastener 100 the handle portion 128 is rotated when the grip features 134 in the upper surface or inward surface of collar 130 engage and mate with the corresponding grip features 134 in the lower surface or outward surface of head 102 of fastening member 100. As such, when the handle portion 128 is rotated the fastener 100 is likewise rotated, thereby tightening or loosening the fastener 100.

To rotate the upper portion 122 without rotating the fastener 100, downward pressure is applied to the handle portion 128 thereby compressing the biasing member 126 such that the grip features 134 in the upper surface or inward surface of collar 130 disengage from the corresponding grip features 134 in the lower surface or outward surface of head 102 of fastening member 100. When the biasing member 126 is compressed the handle portion 128 is rotated. As such, the handle portion 128 is rotated and the fastener 100 remains stationary.

Lower portion 124 has a generally cylindrical exterior surface that fits within the hollow interior of upper portion 122 below collar 130. The upper end of lower portion 124 supports the lower end of biasing member 126. The lower end of lower portion 124 sits upon bushing 140.

Bushing 140 is formed of any suitable size, shape and design. In the arrangement shown, bushing 140 has a generally cylindrical exterior surface 142 that is sized and shaped to be received within the through hole 90 in the forward end of mounting plate 18. Bushing 140 is sized and shaped to fit within close tolerances of through hole 90 while allowing for the mounting plate 18 to be selectively rotated with respect to the bushing 140. To accomplish this, a lip 144 is connected to the upper end of the generally cylindrical exterior surface 142 and extends outward therefrom. That is, lip 144 has a larger diameter than exterior surface 142, and is positioned at the upper end of exterior surface 142. In this way, when bushing 140 is placed within through hole 90, bushing 140 is fully inserted when the bottom surface of lip 144 engages the upper surface 60 of mounting plate 18. In this way, lip 144 prevents bushing from sliding through the through hole 90. In an alternative arrangement, mounting plate 18 includes a step or recess that receives lip 144 such that when bushing 140 is inserted within mounting plate 18, the upper surface 148 of lip 144 is recessed below or flush with the upper surface 60 of mounting plate 18.

A generally centrally positioned through hole 146 extends through the approximate center of bushing 140. This through hole 146 is sized and shaped to allow passage of shaft 104 of fastener 100 there through. Bushing 140 has a generally flat upper surface 148 and a generally flat lower surface 150 which is positioned in generally parallel spaced relation to one another.

An expansion mechanism 160 is positioned below bushing 140. Expansion mechanism 160 is formed of any suitable size, shape and design and serves to selectively expand and contract to anchor system in a mounting hole 14. In one arrangement, as is shown, expansion mechanism 160 is formed of a plurality of components that work in concert with one another to expand and contract the diameter of the expansion mechanism 160 so as to lock within a cylindrical mounting hole 14 or mounting slot in work bench 12 while also being quickly and easily removable.

In the arrangement shown, expansion mechanism 160 includes an upper plug 162. Upper plug 162 is generally cone shaped having a centrally positioned bore 164 that extends there through from generally flat upper surface 164 to a generally flat lower surface 166. Flat upper surface 164 connects at its inward edge to bore 168 and connects at its outward edge to cylindrical exterior wall 170. Cylindrical exterior wall 170 connects to the outward edge of the upper surface 164 and extends downward therefrom before connecting to the upper outward edge of ramp 172. Ramp 172 connects to the lower edge of the cylindrical exterior wall 170 and angles inward as it extends downward before connecting to the outward edge of lower surface 166. Flat lower surface 164 connects at its outward edge to the lower and inward most edge of ramp 172 and connects at its inward edge to bore 168. The surfaces of exterior wall 170 and bore 168 extend in generally parallel spaced relation to one another. The upper surface 164 and lower surface 166 extend in generally parallel spaced relation to one another. In one arrangement, when in place, the flat upper surface 164 of upper plug 162 is positioned in flat and flush engagement with the generally flat lower surface 150 of bushing 140. In another arrangement, upper plug 164 is formed as a continuous part to the bushing 140 and therefore is connected to the lower surface 150 of bushing 140.

A plurality of wedges 180 are positioned just below upper plug 162. Wedges 180 are formed of any suitable size shape and design to form the diameter expanding portion of expansion mechanism 160. In the arrangement shown, wedges 180 are symmetric about a plane extending horizontally through their center, and symmetric about a plane extending vertically through their center.

In the arrangement shown, the four wedges 180 generally form a partial portion of a cylinder having a generally cylindrical exterior surface 182 with a generally cylindrical internal bore 184 extending there through. The cylindrical internal bore 184 is sized and shaped to receive the shaft 104 of fastener 100. The cylindrical exterior surface 182 and cylindrical internal bore 184 extend in approximate parallel spaced relation to one another and in parallel with the axis of fastener 100.

In the arrangement shown, four wedges 180 are shown, each wedge being identical or approximately identical to one another and each wedge 180 forming approximately 90° of the partial portion of the cylinder. However, any other number of wedges 180 are hereby contemplated for use, such as: two wedges 180 with each wedge 180 forming approximately 180° of the partial portion of the cylinder; three wedges 180 with each wedge 180 forming approximately 120° of the partial portion of the cylinder; five wedges 180 with each wedge 180 forming approximately 72° of the partial portion of the cylinder; six wedges 180 or more and so on.

The wedges 180 have a pair of sidewalls 186 that are generally flat and straight and extend generally parallel to the vertical length of wedges 180 and in general alignment with the axis of fastener 100. Sidewalls 186 connect at their outward edge to cylindrical exterior surface 182 and connect at their inward edge to cylindrical internal bore 184. In the arrangement wherein four wedges 180 are used, sidewalls 186 are positioned 90° to one another; in the arrangement wherein three wedges 180 are used sidewalls 186 are positioned 120° to one another, and so on. When the plurality of wedges 180 are connected together to form a partial portion of a cylinder, the sidewalls 186 of adjacent wedges 180 are positioned in flat and flush engagement with one another when expansion mechanism 160 is in a fully collapsed position, and the sidewalls 186 of adjacent wedges 180 are positioned in parallel spaced alignment with one another when expansion mechanism 160 is in a fully collapsed position.

Wedges 180 have a generally flat or rounded upper surface 188 and a generally flat or rounded lower surface 190. The inward edge of the upper surface 188 connects to an upper ramp 192, and the inward edge of lower surface 190 connects to a lower ramp 194. Opposing upper ramp 192 and lower ramp 194 angle inward as they extend from their respective upper surface 188 or lower surface 190 toward the middle of expansion mechanism 160 before connecting to bore 184.

The cylindrical exterior surface 182 of wedges 180 include one or more annular grooves 196. Grooves 196 are formed of any suitable size, shape and design and serve to house and hold an elastic member 198, such as a stretchable O-ring, rubber band or the like. Elastic members 198 hold wedges 180 together in a compressed state while allowing the expansion of the wedges 180 away from one another as is described herein. In the arrangement shown, two grooves 196, each housing and holding an elastic member 198, are placed in the cylindrical exterior surface 182 of expansion mechanism 160, however any other number of grooves 196 are hereby contemplated for use such as one, three, four or more.

A lower plug 210 is positioned below wedges 180. Lower plug 210 is identical or essentially identical to an inverted upper plug 162. That is, lower plug 210 is generally cone shaped having a centrally positioned bore 212 that extends there through from generally flat upper surface 214 to a generally flat lower surface 216. Flat lower surface 216 connects at its inward edge to bore 212 and connects at its outward edge to cylindrical exterior wall 218. Cylindrical exterior wall 218 connects to the outward edge of the lower surface 216 and extends upward therefrom before connecting to the lower outward edge of ramp 220. A ramp 220 connects to the upper edge of the cylindrical exterior wall 218 and angles inward as it extends upward before connecting to the outward edge of upper surface 214. Flat upper surface 214 connects at its outward edge to the upper and inward most edge of ramp 220 and connects at its inward edge to bore 212. The surfaces of exterior wall 218 and bore 212 extend in generally parallel spaced relation to one another. The upper surface 214 and lower surface 216 extend in generally parallel spaced relation to one another.

In one arrangement, the bore 212 of lower plug 210 is threaded and threadably engages the threaded end 106 of shaft 104 of fastener 100 such that as the fastener 100 is rotated the position of lower plug 210 is raised or lowered. This may, or likely, differs from upper plug 162 which in one arrangement has a smooth bore 168 thereby allowing fastener 100 to slidably pass there through. However in other arrangements, bore 168 of upper plug 162 is also threaded and threadably engages shaft 104 of fastener 100. In another arrangement the bore 212 of lower plug 210 is smooth, and in this arrangement a conventional nut is used below lower plug 212 to vertically move lower plug 210.

In one arrangement, the ramped surface 172 of upper plug 162 extends in approximate parallel alignment to the upper ramped surface 192 of wedges 180 such that when the wedges 180 are connected to the upper plug 162 these ramped surfaces 172, 192 are in flat and flush sliding engagement with one another; similarly the ramped surface 220 of lower plug 210 extends in approximate parallel alignment to the lower ramped surface 194 of wedges 180 such that when the wedges 180 are connected to the lower plug 210 these ramped surfaces 194, 220 are in flat engagement with one another.

In Operation: In operation a user desiring to have a bench clamp 10 in a new location away from a track or other conventional mounting member drills a mounting hole 14 in a work bench 12, which can be wood, metal or any other material, at the desired location. Next, the user assembles the system 10.

The user assembles the handle mechanism 120 by inserting the bias member 126 within the hollow interior of the upper portion 122 until the upper end of the bias member 126 engages the lower surface of collar 130. Next, the user inserts the upper end of lower portion 124 within the hollow interior of upper portion 122 until it engages the lower end of the bias member 126, thereby trapping the bias member 126 between the two components 122, 124.

Next, the user inserts the end 106 of fastener 100 through the hollow interior of the upper portion 122, bias member 126 and lower portion 124 of the handle mechanism 120 until the bottom surface of the head 102 of the fastener engages the upper surface of collar 130. In this position, the grip features 108 of the head 102 engage and mate with the grip features 134 in the collar 130 of upper handle portion 122.

Next, the user inserts the end 106 through the through hole 146 in bushing 140 until the bottom surface of lower handle portion 124 engages the upper surface 148 of the bushing 140.

Next, the user inserts the lower surface 150 of bushing 140 into the through hole 90 in mounting plate 18. Once fully inserted the bottom surface of lip 144 engages the upper surface 60 of mounting plate 18, and the lower surface 150 of bushing 140 is in approximate alignment with the lower surface 62 of mounting plate 18.

Next, the user assembles the expansion mechanism 160 by inserting the end 106 of fastener 100 through the bore 168 of upper plug 162 until the upper surface 164 of plug 162 engages the lower surface 150 of bushing 140.

Next, the plurality of wedges 180 held together by elastic members 198 are installed over the shaft 104 of fastener 100 by inserting the end 106 through the bore 184 of combined wedges 180 until the upper ramp 192 of wedges 180 is in flush engagement with the ramped surface 172 of upper plug 162.

Next, the lower plug 210 is installed by inserting the end 106 of fastener 100 through the bore 212 of lower plug 210. In the event that the bore 212 of lower plug 210 is threaded, the lower plug 210 is rotated until the ramped surface 220 engages the lower ramp 194 of wedges 180.

Once the expansion mechanism 160 is formed, the expansion mechanism 160 is inserted into the mounting hole 14 in the work bench 12. Once inserted, the expansion mechanism 160 is expanded to lock in the mounting hole 14. This is accomplished by rotating the handle portion 128 of the upper portion 122 of handle mechanism 120 as the bias member 126 forces upward thereby causing the grip features 134 of the upper portion 122 to engage the grip features 108 in the head 102 of fastener 100 thereby causing rotation of the fastener as the upper portion 122 of the handle mechanism 120 rotates.

As the fastener 100 rotates, due to the threaded bore 212 in lower plug 210 threadably engaging the threads in the lower end 106 of fastener 100, the lower plug 210 is vertically moved. When the lower plug 210 is moved toward the wedges 180, engagement of the ramped surface 220 of lower plug 210 with the lower ramp 194 of wedges 180 and engagement of the ramped surface 172 of upper plug 162 with the upper ramp 192 of wedges 180 causes the ramped surfaces 220, 194 and 172, 192 to slide over one another thereby forcing the wedges 180 outward and away from one another. This essentially expands the exterior surface diameter of wedges 180 thereby locking the wedges 180 within mounting hole 14.

In this position, because the lower surface 150 of the bushing 140 protrudes just a slight distance below the lower surface 62 of the mounting plate 18, the mounting plate 18 is free to rotate around bushing 140 so as to adjust the angular position of mounting plate 18 on bushing 140.

Once the mounting plate 18 is installed and attached to work bench 12 by expansion mechanism 160, the bench clamp 16 is installed thereon. This is accomplished by inserting the head 44 of mounting member 42 into and through the first section 78 of keyhole 76. Once the head 44 of mounting member 42 is inserted through the first section 78 of keyhole 76, the bench clamp 16 is slid forward such that the shaft 46 of mounting member 42 is lockingly received within the second section 80 of keyhole 76. In this position, the base 34 of bench clamp is held within the mounting groove 70 of mounting plate 18 thereby maintaining proper alignment of bench clamp 16 with respect to mounting plate 18.

Once in this position, a workpiece 230 (not shown) is placed under the clamping pad 32. The bench clamp 16 is operated by pressing opposing handles 22, 24 toward one another. This causes the clamping pad 32 to press down on workpiece 230 as the adjustment mechanism 30 adjusts for workpiece thickness until the workpiece 230 is locked against the work bench 12. As the clamping pad 32 presses against the workpiece 230 the bench clamp 16 is prevented from moving upward as the expansion mechanism 160 is firmly held within mounting hole 14 and the head 44 of mounting member 42 is prevented from pulling through the second section 80 of keyhole 76.

To release the workpiece 230, the opposing hands 22, 24 are pulled apart from one another which raises the clamping arm 26 thereby releasing the workpiece.

To remove the mounting plate 18, the fastener 100 is rotated in the opposite direction causing the lower plug 210 to move away from the wedges 180. As the lower plug 210 moves away from the wedges 180 the elastic members 198 pull the wedges 180 closer to one another thereby essentially narrowing the exterior diameter of the expansion mechanism 160 until the expansion mechanism 160 is narrower than the mounting hole 14. Once the expansion mechanism 160 is narrower than the mounting hole 14 the expansion mechanism 160 can be easily removed from mounting hole 14.

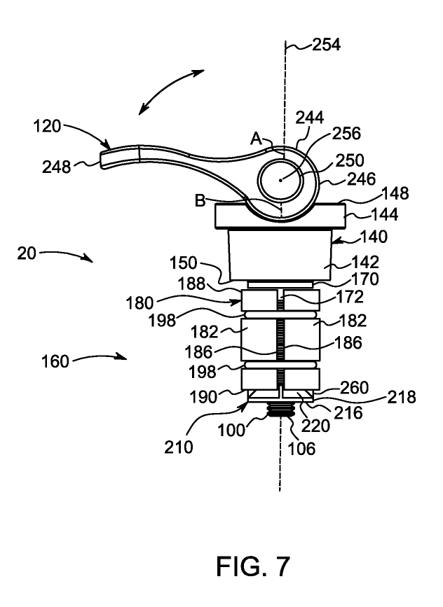

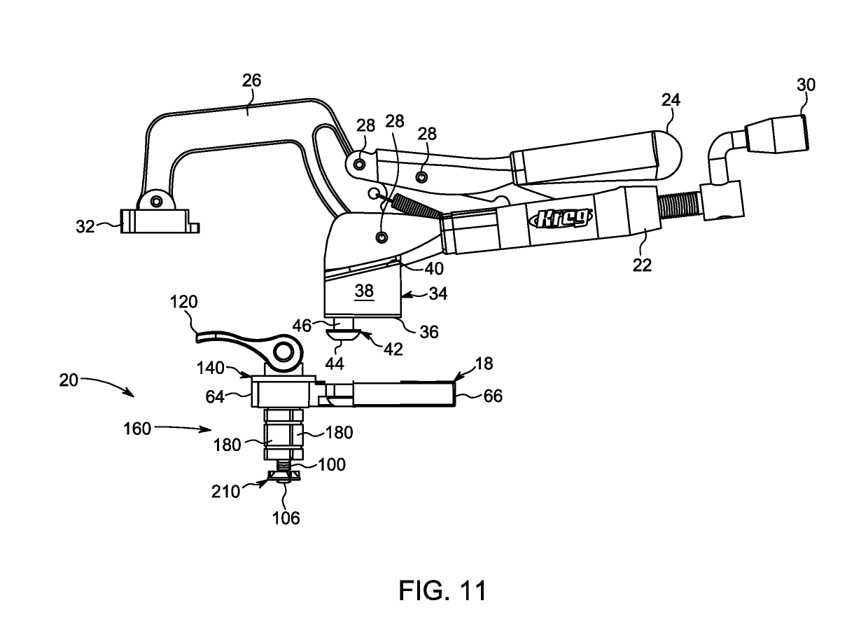

Cam System: With reference to FIGS. 7-13, another example of an expandable locking mechanism, or system 10, is presented. The system 10 presented in FIGS. 7-13 differs from the system 10 presented in FIGS. 1-6 in that the anchor mechanism 20 of the FIGS. 1-6 operates by rotating the handle portion 128 around an axis established by fastener 100 in a clockwise or counterclockwise fashion thereby causing the lower plug 210 to threadably move vertically along a length of fastener 100 as the fastener 100 is rotated; in contrast the anchor mechanism 20 of FIGS. 7-13 operates by rotating the handle portion 128 around an axis that is perpendicular to an axis established by fastener 100 in a toggle-like fashion using a cam thereby causing the lower plug 210 to move vertically by pulling or pushing the lower plug 210. That is, the example of

FIGS. 1-6 is actuated by rotating or screwing handle mechanism 120 whereas the example of FIGS. 7-13 is actuated by flipping or toggling handle mechanism 120. Both examples provide the same or similar result, to expand and contract expansion mechanism 160 by raising or lowering lower plug 210. Each example is particularly suited for various applications and each example provides unique advantages and disadvantages. In addition, these are only two manners and methods of vertically moving lower plug 210 and expanding and contracting expansion mechanism 160. Any other manner or method of vertically moving lower plug 210 and expanding and contracting expansion mechanism 160 is hereby contemplated for use.

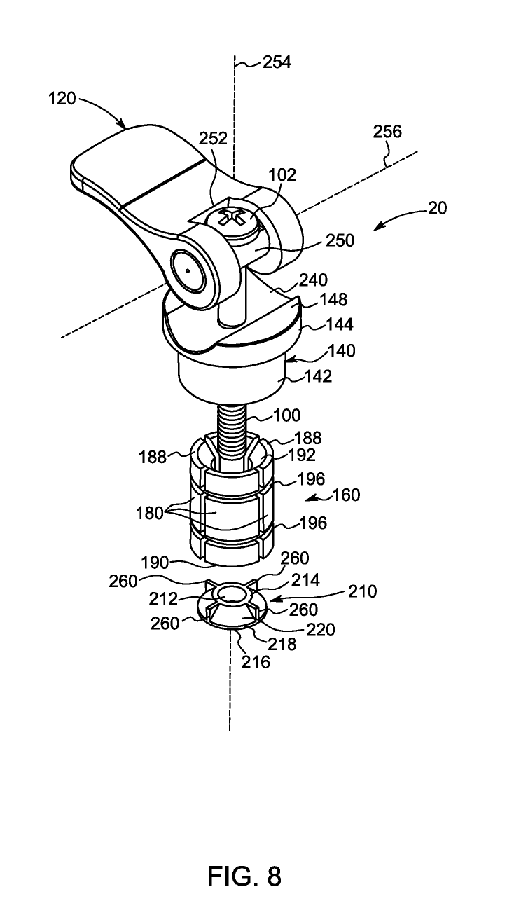

Anchor Mechanism: In the arrangement shown, in FIGS. 7 and 8, as one example, the upper surface 148 of bushing 140 includes a recess 240. More specifically, as one example, recess 240 is placed in the upper surface of lip 144. Recess 240 extends across all of or a portion of the upper surface 148 of bushing 140. In the arrangement shown, as one example, when viewed from the side, recess 240 is arcuate or semi-circular in shape and serves as a cradle that receives a similarly rounded or curved portion of handle mechanism 120 as is further described herein.

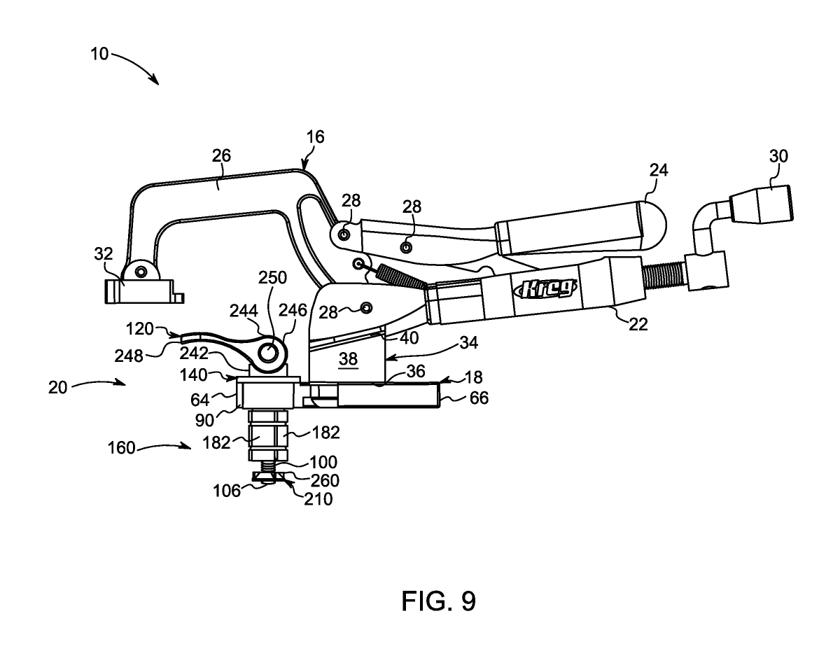

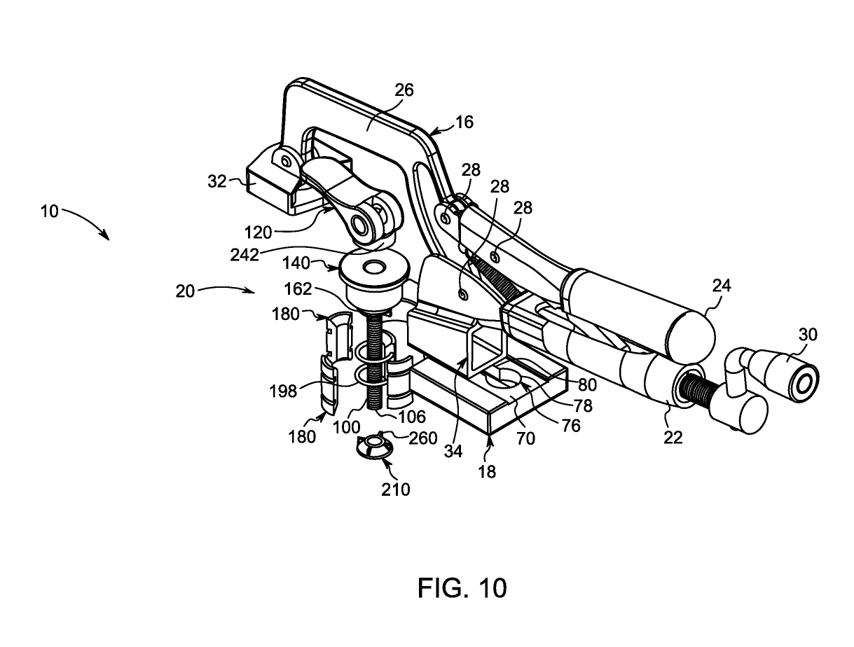

In an alternative arrangement, as is shown in FIGS. 9 and 10, a cap 242 connects to or extends upward from the upper surface 148 of bushing 140, or more specifically the upper surface 140 of lip 144. Cap 242 is either formed as part of bushing 140 or is a separate and individual piece from cap 242. In one arrangement, as is shown, cap 242 has a generally cylindrical exterior surface that is smaller in diameter than the other portions of bushing 140 (namely exterior surface 242 and lip 144) and includes recess 240 in the upper surface of cap 242.

Recess 240, whether it be positioned in the upper surface 148 of bushing 140 or in cap 242, receives a cam surface 244 positioned at the forward end 246 of handle mechanism 120. In the arrangement shown, handle mechanism 120 extends from its forward end 246 which includes the cam surface 244 which is positioned at or wraps around the forward end 246, to its rearward end 248. Handle mechanism 120 is formed of any suitable size, shape and design to be comfortably grasped by a user and is of sufficient size, shape and design to provide adequate leverage to operate expansion mechanism 160. In the arrangement shown, handle mechanism 120 arcuately curves in an ergonomic manner as it extends from the forward end 246 to the rearward end 248.

In one arrangement, when viewed from the side, cam surface 244 is generally arcuate, cylindrical and/or semi-circular in shape and is sized and shaped to be received within recess 204 within tight and close tolerances. When operated by raising or lowering the rearward end 248 of handle mechanism 120, cam surface 244 slides over the surface of recess 240.

An axle 250 is received within an opening in the forward end 246 of handle mechanism 120. Axle 250 is formed of any suitable size, shape and design and serves as a pivot point, or axis of rotation, for handle mechanism 120. In the arrangement shown, axle 250 is generally cylindrical in nature, or has generally cylindrical ends that are received within generally cylindrical openings in the forward end 246 of handle mechanism 120 within close and tight tolerances. This cylindrical engagement between axle 250 and handle mechanism 120 allows for rotation of the handle mechanism 120 with respect to axle 250. In this arrangement, axle 250 is positioned in approximate perpendicular alignment to the length of handle mechanism 120 extending between forward end 246 and rearward end 248.

A slot 252 is positioned in the forward end 246 of handle mechanism 120 that exposes a portion of axle 250. Slot 252 extends between opposing sides of the forward end 246 of handle mechanism 120 at approximately the middle of the width of handle mechanism 120. In this arrangement, the outward sides of handle mechanism 120 engage axle 250, whereas the center portion of axle 250 is free from engagement with handle mechanism 120. This allows for fastener 100 to engage and pass through an opening in axle 250 in its exposed section, at or around its middle. In this way, fastener 100 connects to axle 250 which connects handle mechanism 120 to expansion mechanism 160.

In this arrangement, fastener 100 establishes a first axis 254, or vertical axis, that extends through approximately the center of the length of fastener 100 between end 106 and head 102, and axle 250 establishes a second axis 265, or horizontal axis, that extends through the center of the side-to-side length of axle 250; whereas the first axis 254 of the fastener 100 is positioned in approximate perpendicular alignment with the second axis 256 of the axle 250. This arrangement allows handle mechanism 120 to be rotated or toggled around the axis 256 extending through the center of axle 250, while allowing fastener 100 to be moved vertically along first axis 254.

Upon rotation of handle mechanism 120 with respect to axle 250, cam surface 244 causes fastener 100 to raise or lower. Conventionally, a cam is known as a rotating or sliding piece in a mechanical linkage used in transforming rotary motion into linear motion or vice versa. It is often a part of a rotating wheel (e.g. an eccentric wheel) or shaft (e.g. a cylinder with an irregular shape) that strikes a lever at one or more points on its circular path. In the particular arrangement shown, while the outward ends of axle 250 are round, or generally round, as is the opening in the forward end 246 of handle mechanism 120, to cause the rise and fall of fastener 100 upon rotation of handle mechanism 120, the center axis 256 of axle 250 is offset vertically with respect to the center of the forward end 246 of handle mechanism. That is, for exemplary purposes, as is shown in FIG. 7, when handle mechanism 120 is in a down position, the distance A at the upper portion of cam surface 244 is narrower than the distance B at the lower portion of cam surface 244. In this arrangement, the further the rearward end 248 of handle mechanism 120 is moved lower the further fastener 100 is vertically raised; and the opposite is true. That is, the further the rearward end 248 of handle mechanism 120 is moved higher the further fastener 100 is vertically lowered. This is because as the cam surface 244 arcuately transitions from point A to point B the thickness of material between the exterior surface of axle 250 and cam surface 244 increases. In contrast as the cam surface 244 arcuately transitions from point B to point A the thickness of material between the exterior surface of axle 250 and cam surface 244 decreases.

In the arrangement shown, as one example, the curvature of cam surface 244 is constant, such as a constant cylindrical shape. In this arrangement, the offset of the axle 250 with respect to the center of the forward end 246 of handle mechanism 120 causes the rise and fall of fastener 100. In an alternative arrangement, instead of cam surface 244 having a constant curvature, the cam surface 244 has a varying curvature or dimensions that causes the rise and fall of fastener 100 as handle mechanism 120 is rotated. In one way of describing it, this arrangement would be known as a cam lobe or cam protrusion.

As is also shown in FIGS. 7-12, upper plug 162 and lower plug 210 include one or more fins 260. Fins 260 are formed of any suitable size, shape and design and serve to help prevent unintentional rotation of upper plug 162 and lower plug 210 upon fastener 100. In the arrangement shown, as one example, fins 260 are generally narrow pieces of material that are aligned to fit between the upper and lower ends of adjacent wedges 180. In this way, fins 260 help to index between adjacent wedges 180 which helps to maintain alignment of upper plug 162 and lower plug 210 with respect to wedges 180 as well as prevent unintentional rotation of upper plug 162 and lower plug 210 with respect to wedges 180 and/or fastener 100.

As one example, as is shown, fins 260 have an exterior wall that extends in approximate parallel or flush alignment with the exterior wall 170 of upper plug 162, and the exterior wall 218 of lower plug 210, respectively. That is, in the arrangement shown, fins 260 do not laterally protrude beyond the other portions of upper plug 162 and lower plug 210. As is also shown, fins 260 terminate in parallel or flush alignment with the upper end of lower plug 210 or lower end of upper plug 162, respectively. That is, in the arrangement shown, fins 260 do not vertically protrude above or below the other portions of upper plug 162 and lower plug 210.

In one arrangement, upper plug 162 is formed as part of bushing 140 such that upper plug 162 and bushing 140 form a single solid and unitary piece. In an alternative arrangement, upper plug 162 is a separate piece from bushing 140.

In the arrangement shown, four fins 260 are shown which correlates with the number of wedges 180 used. This arrangement allows for a fin 260 to be positioned between each adjacent set of wedges 180. However any number of fins 260 is hereby contemplated for use such as one, two, three or more wedges. However, in some arrangements it is desirable to have an equal number fins 260 as there are wedges 180.

In one arrangement, lower plug 210 includes a threaded bore 212 that threadably engages the threaded exterior surface of fastener 100. In an alternative arrangement, the bore 212 of lower plug 210 is smooth and a conventional nut or other threaded member is threadably engaged with fastener 100 and positioned below lower plug 201.

Applications: Anchor mechanism 20, whether it be the rotatably actuated anchor mechanism 20 presented in FIGS. 1-6 or the toggle actuated anchor mechanism 20 presented in FIGS. 7-13, may be used to connect to any cylindrical opening or elongated groove or slot that has a diameter or width, respectively, that is slightly larger than the compressed diameter of expansion mechanism 160 but smaller than the maximum expanded diameter of expansion mechanism 160.

Mounting Plate: As is shown in FIGS. 9, 10 and 11, anchor mechanism 20 is shown in use with a mounting plate 18. In these figures, an improved bench clamp 16 is attached to mounting plate 18 after anchor mechanism 20 is attached, bench clamp 16 is attached to mounting plate 18 by inserting mounting member 42 of base 34 into the key hole 76 of mounting plate 18. The improved bench clamp 16 shown in FIGS. 9, 10 and 11 depict the auto-adjusting bench clamp manufactured by Applicant, Kreg Enterprises, Inc., d/b/a Kreg Tool. This device includes the tension adjustment mechanism 30 positioned at the end of lower handle 22. However, once mounting plate 18 is attached to work bench 12 by anchor mechanism 20, it is hereby contemplated that any device, tool or object may be attached to mounting plate 18 in the manner described herein.

While mounting plate 18 shown herein includes only a single through hole 90 that receives a single anchor mechanism 20, alternative arrangements are hereby contemplated wherein mounting plate 18 includes two or more through holes 90 which receive an anchor mechanism 20 therein and require a corresponding number of mounting holes 14 to attach to work bench 12. When two or more anchor mechanisms 20 are used to attach a mounting plate 18 to a work bench, mounting plate 18 is held statically or non-rotatably in place. That is, unlike the arrangement shown in FIGS. 1, 2, 3, 9, 10 and 11 which allows mounting plate 18 to rotate around mounting hole 14 after anchor mechanism 20 is affixed to mounting hole 14, in the arrangement where two or more anchor mechanisms 20 are used to attached a mounting plate 18 to a work bench 12 the mounting plate 18 is prevented from freely rotating. In this way, the two anchor mechanisms 20 provide alignment to the mounting plate 18. Similarly, it is hereby contemplated that mounting plates 18 may include two or more keyholes 76 therein that each receive a mounting member 42 therein attached to a tool, object or device (such as a bench clamp 16, or the like). Similarly, this arrangement where mounting plate 18 includes a plurality of keyholes 76 provides additional alignment to the tool or object attached to mounting plate 18 by mounting members 42 which is advantageous in many applications. This arrangement of a mounting plate 18 having multiple anchor mechanisms 20 and/or multiple keyholes 76 may be useful when additional security, safety or alignment is needed, or when attaching larger or heavier objects or tools to mounting plate 18 and work bench 12, or when it is necessary or important to ensure the object or tool attached to mounting plate 18, or mounting plate 18 itself, does not move.

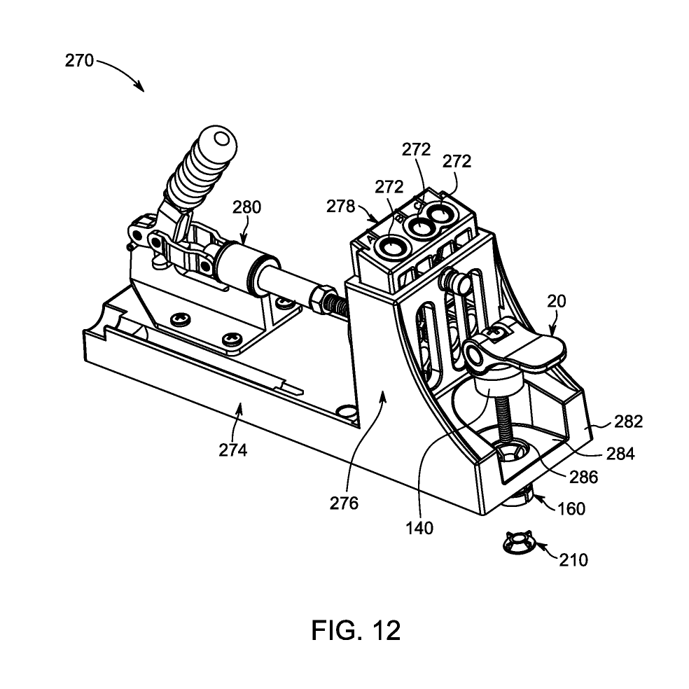

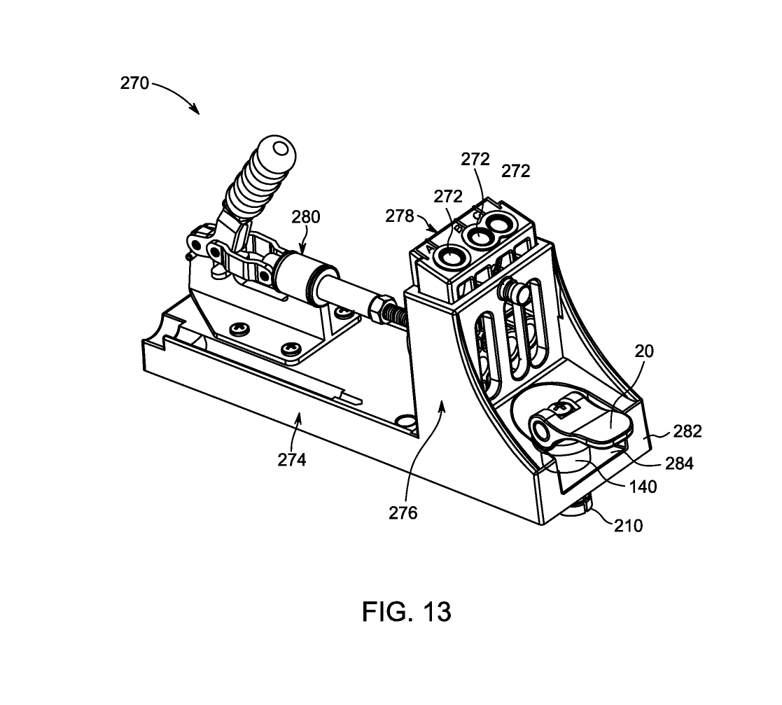

Pocket Hole Jig: As one example, as is shown in FIGS. 12 and 13, anchor mechanism 20 is used to connect a pocket hole jig 270 to work bench 12. Pocket hole jig 270 is a form of a woodworking tool that clamps a workpiece in place and provides one or more drilling guides 272 that guide a stepped drill bit to drill into the workpiece at an angle. Applicant owns a plurality of patents and patent applications directed to pocket hole jigs including U.S. Pat. No. 4,955,766 entitled “Holding Fixture For Drilling Pocket Joints” filed on Nov. 6, 1989 listing inventor Craig A. Sommerfeld, which is incorporated herein by reference including all related applications and all patents and patent applications that reference this patent.

As one example, as is shown, pocket hole jig 270 includes a base 274 that sits upon work bench 12. An upright 276 extends upward from base 274 and includes an adjustable guide member 278 that includes a plurality of drilling guides 272. A clamping mechanism 280 is connected to base 274 and serves to force a workpiece into flat and flush engagement with upright 276 and guide member 278. Once clamped in place, the pocket holes can be drilled using drilling guides 272.

In the arrangement shown, the rearward end 282 of pocket hole jig 270 includes a recessed platform 284. Platform 284 is a generally flat recess in the rearward end 282 of pocket hole jig 270 that conventionally is used to clamp pocket hole jig 270 to work bench 12. While this is advantageous, this arrangement has its disadvantages. Namely, without more, the pocket hole jig 270 is limited to being clamped to work bench 12 at the edge of the work bench 12 due to the fact that the reach of most conventional clamps (such as C-clamps) are limited. This limits the use of pocket hole jig 270 to the edge of work bench 12 which may be undesirable in many applications.

To alleviate this problem, as is shown, platform 284 includes an opening 286 therein that is sized and shaped to receive bushing 140 therein. This arrangement allows pocket hole jig 270 to be attached to work bench 12 at any position where a mounting hole 14 is or can be located. This frees the pocket hole jig 270 to be mounted away from the edge of work bench 12. This freedom is advantageous in many applications and allows for a safer application and use of pocket hole jig 270 in many situations.

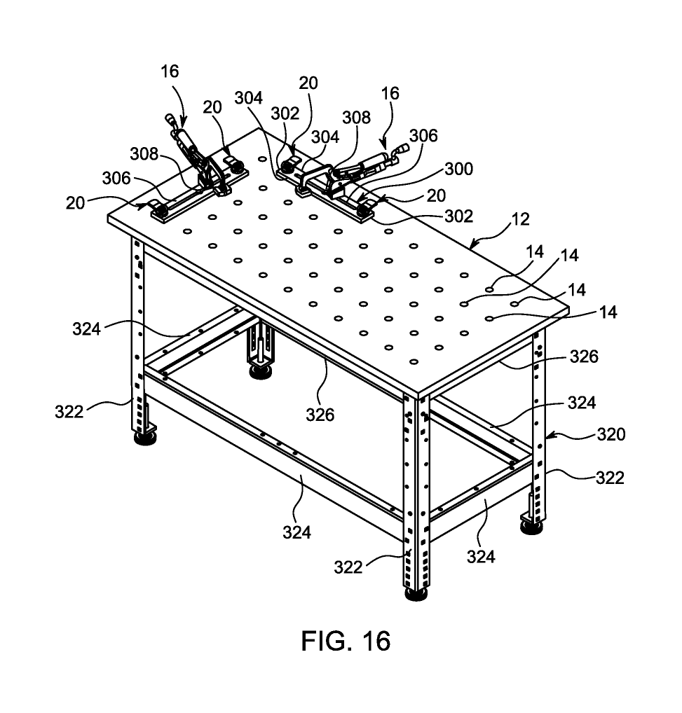

Track: As another example, as is shown in FIG. 16, anchor mechanisms 20 are used to connect a track 300 to work bench 12. Track 300 is formed of any suitable size shape and design and serves to be easily connected to work bench 12 and allows for easy connection of tools to track 30 for use with workpieces placed on work bench 12. In the arrangement shown, as one example, track 300 extends a length between opposing ends 302 connected by elongated sides 304. The upper surface of track 300 includes a slot 306 therein that extends a distance between ends 302 in parallel spaced alignment with sides 304. As is shown, slot 306 includes an entry point 308 that is akin to the first section 78 of keyhole 76 presented with respect to mounting plate 18. That is, entry point 308 is an opening in slot 306 that is wider than the other portions of slot 306 thereby allowing the head 44 of a mounting member 42 to pass there through, while head 44 is prevented from pulling out of slot 306, in a similar or identical manner described above with respect to mounting plate 18. Once head 44 of mounting member 42 is inserted through entry point 308 of slot 306, the bench clamp 16 is free to slide to any position along slot 306.

While a bench clamp 16 is shown connected to track 300, any form of a tool, device or object can be attached to track 300 and is hereby contemplated for use. A bench clamp is only one of countless examples.

Track 300 includes an opening 310 (covered by anchor mechanism 20 in FIG. 16) in each end of track 300 that receives anchor mechanism 20. Openings 310 are positioned at or near the ends 302 of track 300. In this way, once each anchor mechanism 20 is attached to track 300 and affixed to a mounting hole 14, as each end of track 300 is prevented from moving, eliminating rotation of track 300 or other unintentional movement of track 300. This is particularly advantageous in applications where precision is required or multiple tracks 300 are used and it is necessary to maintain a particular alignment between the multiple tracks 300, such as in the arrangement shown in FIG. 16 where a first track 300 is positioned in perpendicular alignment to a second track 300. In this arrangement, track 300 is quickly and easily attached to the top surface of work bench 12 by a pair of anchor mechanisms 20 without the use of tools.

Bench Dog: In one arrangement, system 10, whether it be the rotatably actuated anchor mechanism 20 presented in FIGS. 1-6 or the toggle actuated anchor mechanism 20 presented in

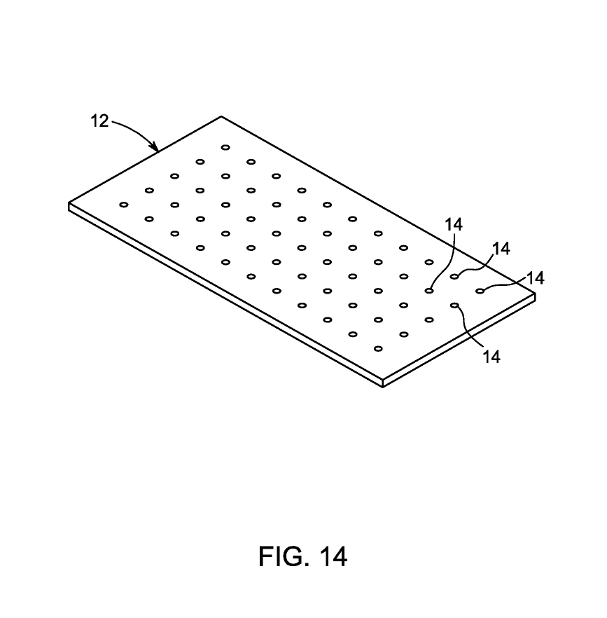

FIGS. 7-13, may be advantageously used with a work bench 12 having mounting holes 14 positioned in a precise grid. As an example, with reference to FIGS. 14-17, a work surface or work bench 12 having mounting holes 14 positioned in a precise grid of equal spacing is presented. That is, a plurality of mounting holes 14 are aligned in equally spaced rows of equally spaced mounting holes 14. Work benches having a grid of hole therein are known in the industry as a “bench dog”. While this arrangement is not new, the use is new. That is, conventionally a bench dog is used by placing pegs in desired mounting holes 14. These pegs are then used as alignment references for workpieces.

In contrast to the conventional use of a bench dog, anchor mechanisms 20 are used to mount tools, such as bench clamps 16 (either directly or by way of mounting plate 18), pocket hole jigs 270, tracks 300 or any other tool or object directly to the work bench 12. Because the mounting holes 14 of the bench dog work bench 12 are positioned at precise spacing or intervals, measurement and alignment is quickly and easily facilitated.

One advantage of using a bench dog work bench 12 is that tools can be manufactured with openings therein that automatically align with the mounting holes 14 of bench dog work bench 12. As an example, as is shown in FIG. 16, tracks 300 include openings 310 (hidden by anchor mechanisms 20) that are spaced to automatically fit the mounting holes 14 of bench dong work bench 12. This allows for tracks 300 to be attached to bench dog work bench using anchor mechanisms 20 quickly, easily and without any tools. Furthermore, once attached, due to this alignment, tracks 300 are precisely aligned along one of the grid of mounting holes 14. As is shown in FIG. 16, the tracks 300 are positioned in perpendicular alignment to one another. This is incredibly advantageous in many applications such as frame making, cabinetry or the like. In addition, due to the unique arrangement of expansion mechanism 160, expansion mechanism 160 tends to expand in a constant and generally equal and centered manner which further helps to ensure proper alignment when anchor mechanism 20 is attached to mounting holes 14 as expansion mechanism 160 tends to be self-centering within mounting hole 14 as it expands.

As one example, the bench dog work bench 12 may be used in a stand-alone manner as is shown in FIG. 14.

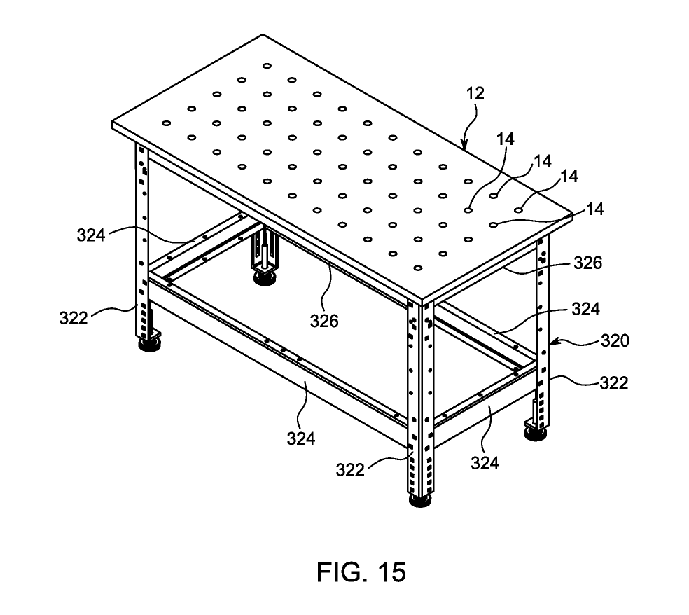

As another example, as is shown in FIGS. 15 and 16, bench dog work bench 12 may be used with a work bench frame 320. In one arrangement, as is shown, frame 320 includes a plurality of legs 322 connected by cross braces 324 at or near their midsection or lower end and connected by an upper frame member 326 at or near their upper end. In this arrangement, the bench dog work bench 12 may be quickly and easily removably attachable to the frame 320 by alignment of openings 328 (covered by the work bench 12 itself) in the upper surface of frame 320 that receive anchor mechanisms 20 therein that facilitate connection of bench dog work bench 12 to frame 320. That is, the upper surface of frame 320 includes openings 328 (not shown) that are spaced to precisely align with mounting holes 14 in work bench 12. Once work bench 12 is placed on top of the frame 320, these holes or openings 328 are aligned, and anchor mechanisms 20 are inserted and actuated. Once the expansion mechanism 160 of the anchor mechanism 20 expands within the aligned openings 238 in the top surface of upper frame member 326 of frame 320, the work bench 12 is affixed to the frame 320. In one arrangement, an anchor mechanism 20 is placed in each corner of the work bench 12 and frame 320 to ensure a strong and durable connection there between. To provide the broadest base and the greatest stability, the outward most mounting holes 14 are used for connection to frame 320.

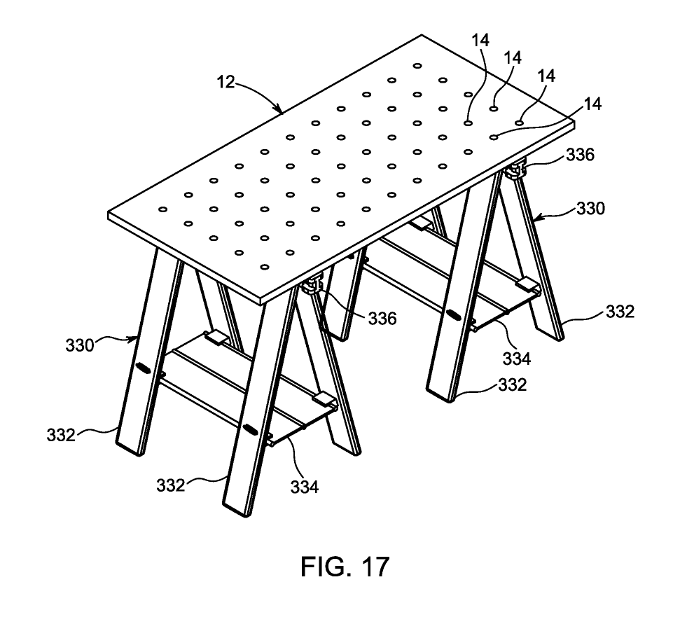

As yet another example, as is shown in FIG. 17 a pair of saw horses 330 are presented that, like frame 320, support bench dog work bench 12. Saw horses 330 include a plurality of legs 332 that connect to one another by a cross brace 334 at their mid or lower sections. Legs 332 also connect at their upper end to a frame member 336. Frame member 336 includes a plurality of openings 338 (covered by the work bench 12 itself) in the upper surface of frame members 336 that receive anchor mechanisms 20 therein that facilitate connection of bench dog work bench 12 to saw horses 330. That is, the upper surface of frame members 336 include openings 338 (not shown) that are spaced to precisely align with mounting holes 14 in work bench 12. Once work bench 12 is placed on top of the saw horses 330, these holes or openings 338 are aligned, and anchor mechanisms 20 are inserted and actuated. Once the expansion mechanism 160 of the anchor mechanism 20 expands within the aligned openings 338 in the top surface of upper frame member 336 of saw horses 330, the work bench 12 is affixed to the saw horses 330. In one arrangement, a pair of anchor mechanisms 20 connect to each upper frame member 336 at each outward end of the upper frame member 336 to ensure a strong and durable connection there between. This arrangement provides a rigid bench dog work bench 12 that is quickly and easily assembled and disassembled using saw horses 330. To provide the broadest base and the greatest stability, the outward most mounting holes 14 are used for connection to saw horses 330.

In Operation:

In operation, a user desiring to affix a tool (be it a bench clamp 16, pocket hole jig 270, a track 300 or any other tool) to a mounting hole 14 in a work bench 12, or a bench dog work bench 12, using the expansion mechanism 20 shown in FIGS. 7-13 and 16, initially checks to ensure the compressed diameter of the expansion mechanism 160 is slightly smaller than the applicable mounting hole 14. This is done by flipping the rearward end 248 of the handle mechanism in the fully up position. In this position, the narrowest portion of the cam surface 244 is between the bushing 140 and the axle 250. This ensures that the fastener 100 is in its lowest position and thereby causes the lower plug 210 to move to its lowest position. As the lower plug 210 moves downward, the elastic members 198 cause the wedges 180. If in this position, the compressed diameter of the expansion mechanism 160 must be adjusted, the user simply rotates the lower plug 210 downward (to narrow the diameter of the expansion mechanism 160) or upward (to widen the diameter of the expansion mechanism 160).

Once the compressed diameter of the expansion mechanism 160 is properly set, the user aligns the opening in whatever it is that the user intents to attach to the work bench 12 with a mounting hole in the work bench 12.

As an example, with reference to FIGS. 9, 10 and 11, anchor mechanism 20 is used to affix a mounting plate 18 to a work bench 12. In this arrangement, the user aligns the opening 90 in the forward end 64 of mounting plate 18 with a mounting hole 14 in work bench 12. Once aligned, the user inserts the anchor mechanism 20 into the aligned opening 90 and mounting hole 14 until the bushing 140 is fully received within the opening 90. In this position, the lower surface of lip 144 engages an upper surface of mounting plate 18 adjacent opening 90.

Once in this position, the user lowers the rearward end of handle mechanism 248. This causes the forward end 246 of handle mechanism 120 to rotate upon axle 250. As the rearward end 248 of handle mechanism 120 rotates downward, the cam surface 244 of the forward end 246 of handle mechanism slides within recess 240 in lip 144 of bushing 140 or cap 242 positioned on top of busing 140. As the handle mechanism 120 rotates downward, the thickness of material between the recess 240 and the axle 250 increases thereby causing the fastener 100 to rise. As the fastener 100 rises, this pulls the lower plug 210 upward. As the lower plug 210 is pulled upward, the lower ramp 194 of wedges 180 slides outward over the ramp 220 of the lower plug 201 and simultaneously the upper ramp 192 of wedges 180 slides outward over the ramp 172 of the upper plug 162. This causes the diameter of expansion mechanism 160 to expand against the contracting force of elastic members 198. This expansion continues until the handle mechanism 120 is in its fully downward position. In this position, the mounting plate 18 is affixed to the work bench 12, however in the arrangements wherein the bushing 140 is taller than the mounting plate 18, the mounting plate 18 is freely rotatable around bushing 140.

Once the mounting plate 18 is affixed to work bench, the user attaches a tool, such as bench clam 16 to mounting plate 18 as is described herein.

As another example, with reference to FIGS. 12 and 13, anchor mechanism 20 is used to affix a pocket hole drilling jig 270 to a work bench 12. In this arrangement, the user aligns the opening 286 in the rearward end 282 of pocket hole drilling jig 270 with a mounting hole 14 in work bench 12. Once aligned, the user inserts the anchor mechanism 20 into the aligned opening 286 and mounting hole 14 until the bushing 140 is fully received within the opening 286. In this position, the lower surface of lip 144 or bushing 140 engages an upper surface of platform 284 adjacent opening 286.

Once in this position, the user lowers the rearward end of handle mechanism 248 and the process, as is described herein, occurs thereby affixing pocket hole drilling jig 270 to a mounting hole in work bench 12.

As yet another example, with reference to FIGS. 14, 15 and 16, anchor mechanisms 20 are used to affix a bench dog work bench 12 to a frame 320 to form a standing bench dog work bench system using frame 320. In this arrangement, the user aligns the openings 328 in the upper surface of upper frame members 326 with mounting holes 14 in the bench dog work bench 12. The openings 328 in the upper surface of upper frame members 326 are spaced at the identical spacing as the mounting holes 14 in the bench dog Once aligned, the use the user inserts the anchor mechanism 20 into the aligned opening 328 and mounting holes 14 until the expansion mechanisms 160 are received within the openings 328.

Once in this position, the user lowers the rearward end of handle mechanism 248 and the process, as is described herein where the expansion mechanism 160 expands within opening 328 occurs, thereby affixing bench dog work bench 12 to frame 320.

As yet another example, with reference to FIG. 17, anchor mechanisms 20 are used to affix a bench dog work bench 12 to a pair of saw horses 330 to form a standing bench dog work bench system using saw horses 330. In this arrangement, the user aligns the openings 338 in the upper surface of upper frame members 336 with mounting holes 14 in the bench dog work bench 12. Once aligned, the use the user inserts the anchor mechanism 20 into the aligned opening 338 and mounting holes 14 until the expansion mechanisms 160 are received within the openings 338.

Once in this position, the user lowers the rearward end of handle mechanism 248 and the process, as is described herein where the expansion mechanism 160 expands within opening 338 occurs, thereby affixing bench dog work bench 12 to saw horses 330.

As yet another example, with reference to FIG. 16, anchor mechanisms 20 are used to affix a plurality of tracks 300 to a bench dog work bench 12. In this arrangement, tracks 30 have openings 310 (hidden by fastening member 20) positioned in their ends 302 that are spaced to align with mounting holes 14 in bench dog work bench 12. To attach the tracks 300 to a bench dog work bench 12 the user aligns openings 310 with a pair of mounting holes 14. Once the openings 310 and mounting holes 14 are aligned, the user inserts the anchor mechanism 20 into the aligned opening 310 and mounting holes 14 until the expansion mechanisms 160 are received within the mounting holes 14.

Once in this position, the user lowers the rearward end of handle mechanism 248 and the process, as is described herein where the expansion mechanism 160 expands within mounting holes 14, thereby affixing the track 300 to the bench dog work bench 12. Because the openings 310 on the ends 302 of tracks 300 are precisely spaced to match the grid of mounting holes 14 in the bench dog work bench 12, once affixed using anchor mechanisms 20, tracks 300 are precisely aligned along the orientation established by the grid of mounting holes 14. As is shown in FIG. 16, a pair of tracks 300 are mounted in precise perpendicular alignment to one another. Similarly two tracks 300 could be mounted in precise parallel alignment or parallel spaced alignment by attaching tracks 300 to mounting holes 14 that are aligned in parallel to one another.

Any other tool or device can be mounted to work bench 12 or bench dog work bench 12 in the manner(s) described herein.

Accordingly, from the above discussion it will be appreciated that the improved bench clamp and method of use presented offers many advantages over the prior art. Specifically, the improved bench clamp and method of use improves upon the present state of the art; allows for installation on practically any work bench ; can be installed at practically any place on a work bench; does not require a track system to install the bench clamp; allows for quick and uncomplicated; is simple to use; is easy to use; does not require connecting any additional parts or components to a work bench to install the system; is safe to use; is relatively inexpensive; provides new and additional ways of using a bench clamp; allows for added flexibility of use; can be used with a wide array of work processes; can be used in a wide array of industries; can be used with a wide array of workpiece thicknesses, quickly and easily; is robust; is forgiving; has a long useful life; is durable; has an intuitive design; improves the speed and ease of performing work processes; among countless other improvements and advantages.

It will be appreciated by those skilled in the art that other various modifications could be made to the device without parting from the spirit and scope of this invention. All such modifications and changes fall within the scope of the claims and are intended to be covered thereby.

What is claimed:

1. An expandable bench clamp locking system comprising:
a mounting plate;
an anchor mechanism connected to the mounting plate; and
the anchor mechanism having a shaft connected to an expansion mechanism such that when the expansion mechanism is inserted within a mounting hole a diameter of the expansion mechanism expands and locks within the mounting hole.

2. The bench clamp locking system of claim 1 wherein the expansion mechanism is formed of a plurality of wedges.

3. The bench clamp locking mechanism system of claim 1 wherein the expansion mechanism is formed of a plurality of wedges having an upper ramped surface and a lower ramped surface.

4. The bench clamp locking system of claim 1 wherein the expansion mechanism is includes a lower plug having a ramped surface that moves toward the expansion mechanism.

5. The bench clamp locking system of claim 1 further comprising a plug connected to the shaft below the expansion mechanism that moves toward the expansion mechanism.

6. The bench clamp locking system of claim 1 further comprising a bench clamp removably connected to the mounting plate.

7. The bench clamp locking system of claim 1 wherein the anchor mechanism includes a bushing positioned within an opening of the mounting plate, wherein the mounting plate is rotatable on the bushing.

8. An expandable bench clamp locking system comprising:
a mounting plate;
a bushing connected to the mounting plate;
an expansion mechanism positioned below the upper plug;
a lower plug positioned below the expansion mechanism;
a shaft extending through the bushing, expansion mechanism and lower plug; and
wherein when the lower plug is moved toward the expansion mechanism the expansion mechanism expands.

9. The bench clamp locking system of claim 8 wherein the lower plug has a ramped surface that engages a ramped surface of the expansion mechanism.

10. The bench clamp locking system of claim 8 wherein the expansion mechanism is formed of a plurality of wedges.

11. The bench clamp locking system of claim 8 wherein the mounting plate rotates upon the bushing.

12. The bench clamp locking system of claim 8 wherein bushing is received within an opening in the mounting plate.

13. The bench clamp locking system of claim 8 further comprising a handle mechanism connected to the shaft.

14. The bench clamp locking system of claim 8 further comprising a bench clamp removably connected to a connecting feature.

15. The bench clamp locking system of claim 8 further comprising an upper plug positioned between the bushing and the expansion mechanism.

16. The bench clamp locking system of claim 8 further comprising a mounting groove positioned in the mounting plate.

17. The bench clamp locking system of claim 8 further comprising a keyhole in the mounting plate and a bench clamp removably connected to the keyhole.

18. A method of using an expandable bench clamp locking system, the method comprising the steps of:
providing a mounting plate having an anchor mechanism connected to the mounting plate, the anchor mechanism having a shaft extending through the mounting plate and connected to an expansion mechanism positioned below the mounting plate;
inserting the expansion mechanism into a mounting hole in a work bench; and
causing the expansion mechanism to expand thereby locking the mounting plate to the work bench.

19. The method of using an expandable bench clamp locking system of claim 18 further comprising the step of connecting a bench clamp to the mounting plate.
